(19) United States
(12) Patent Application Publication
(10) Pub. No.: US 2009/0290326 A1
(43) Pub. Date: Nov. 26, 2009

(54) COLOR SELECTION INTERFACE FOR AMBIENT LIGHTING

(76) Inventors: Kevin Mark Tiedje, Farmington Hills, MI (US); Matthew Mark Mikolajczak, Novi, MI (US)

Correspondence Address: FRASER CLEMENS MARTIN & MILLER LLC, 28366 KENSINGTON LANE, PERRYSBURG, OH, 43551, US

(21) Appl. No.: 12/125,493

(22) Filed: May 22, 2008

(51) Int. Cl. F21V 33/00

(52) U.S. Cl. 362/85

(57) ABSTRACT

A color selection interface and a method for selectively modulating a color output of a lighting system, wherein the color selection interface provides control of the color output of the lighting system and a real-time color feedback to a user is disclosed. The color selection interface includes a user interface having a rotary encoder adapted to transmit an encoder output representing a direction of rotation of the rotary encoder, wherein the user interface provides a direct control of an initiation, a stopping, and a morphing speed of a color morphing mode, and a controller in electrical communication with the light source and the user interface, wherein the controller is adapted to receive the encoder output and control the color output of the lighting system in response to the encoder output.

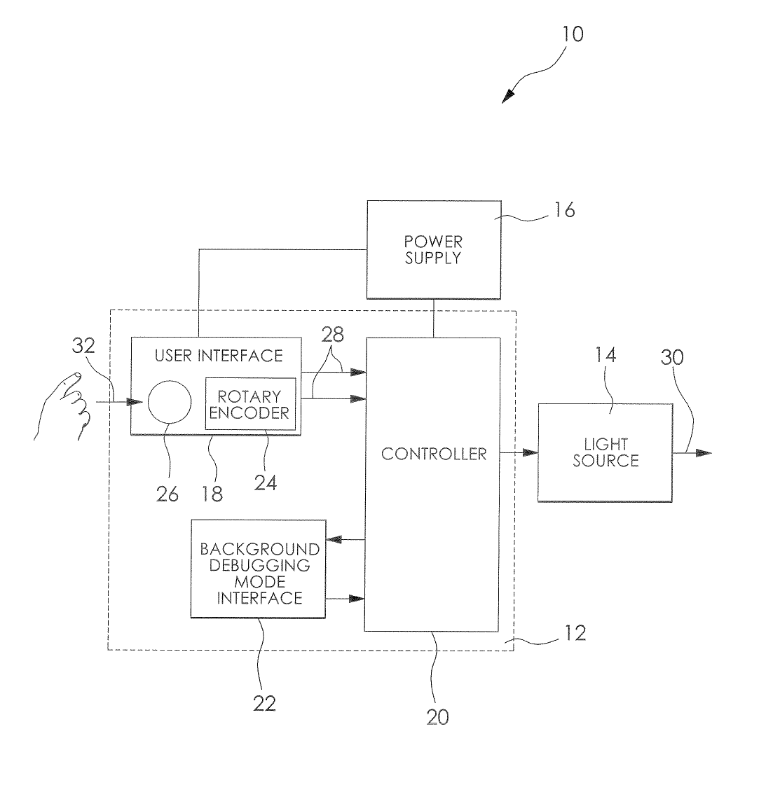

### FIELD OF THE INVENTION

The present invention relates to lighting. More particularly, the invention is directed to a color selection interface for selectively modulating a color output of a lighting system.

### BACKGROUND OF THE INVENTION

The mixing of colors emitted by Light Emitting Diodes (LEDs) to create a personally desirable color can be a complex and confusing task. Typically three input control devices are required for adjusting the brightness of a red, blue, and green LED to create a desired color. With 1 million color possibilities this presents a very difficult and time consuming situation.

Ambient lighting output from a lighting system typically consists of a set of pre-programmed fixed colors. The pre-programmed colors limit the end-user's color choice and may not contain the customer's personal color preference. Further, the ambient lighting is often programmed without knowing the end user's lighting system backgrounds such as carpeting, seats, instrument panel, and the like, thereby making the fixed color selection a non optimal solution.

It would be desirable to have a color selection interface and a method for selectively modulating a color output of a lighting system, wherein the color selection interface provides control of the color output of the lighting system and a real-time color feedback to a user.

### SUMMARY OF THE INVENTION

Concordant and consistent with the present invention, a color selection interface and a method for selectively modulating a color output of a lighting system, wherein the color selection interface provides control of the color output of the lighting system and a real-time color feedback to a user, has surprisingly been discovered.

In one embodiment, a color selection interface for controlling the output of a light source comprises a user interface including a rotary encoder adapted to transmit an encoder output representing the direction of rotation of the rotary encoder, wherein the user interface provides a direct control of an initiation of a color morphing mode, a stopping of the color morphing mode, and a morphing speed of the color morphing mode, and a controller in electrical communication with the light source and the user interface, wherein the controller is adapted to receive the encoder output and control the output of the light source in response to the encoder output.

In another embodiment, a lighting system comprises a light source having at least one color light emitting diode (LED), a user interface including a rotary encoder adapted to transmit an encoder output representing the direction of rotation of the rotary encoder, wherein the user interface provides a direct control of an initiation of the color morphing mode, a stopping of the color morphing mode, and a morphing speed of the color morphing mode, and a controller in electrical communication with the light source and the user interface, wherein the controller is adapted to receive the encoder output and control the color output of the light source in response to the encoder output.

The invention also provides methods for selectively modulating a color output of a lighting system.

One method comprises the steps of: providing a light source adapted to emit a color output; providing a color selection interface in electrical communication with the light source, wherein the color selection interface is adapted to receive at least one user-provided input and modulate the color output of the light source in response to the at least one user-provided input; and providing a user input for controlling at least one of an initiation of the modulation of the color output, a stopping of the modulation of the color output, and a speed of the modulation of the color output.

### BRIEF DESCRIPTION OF THE DRAWINGS

The above, as well as other advantages of the present invention, will become readily apparent to those skilled in the art from the following detailed description of the preferred embodiment when considered in the light of the accompanying drawing which is a schematic block diagram of a light system according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

Referring to the FIGURE, there is illustrated a lighting system 10 according to the present invention. The lighting system 10 includes a color selection interface 12, a light source 14, and a power supply 16. It is understood that other components may be included in the lighting system 10, as desired.

In one embodiment, the light source 14 is at least one tri-color Light Emitting Diode (LED) package adapted to emit a plurality of visible colors. As a non-limiting example, each tri-color LED package contains three individual LEDs of red, green, and blue. It is understood that any number of light emitting devices may be included, as desired. It is further understood that any device for emitting color light may be used such as a plurality of single color LEDs or a bi-color LED, for example. In certain embodiments, the light source 14 includes a separate electrical lead for each LED color, thereby providing for an individualized control of each color's brightness. Where a plurality of LEDs is used, each LED having a similar output color may be controlled by a single electrical lead in electrical communication with each of the similarly colored LEDs. As such, the brightness of each of the similarly colored LEDs will be substantially similar to each other. It is understood that other electrical configurations may be used, as desired.

The power supply 16 may be any source of electrical energy for transmitting electric current to the color selection interface 12, the light source 14, and any other electrical component of the lighting system 10. It is understood that the lighting system 10 may have a dedicated power supply 16 or a lead from a shared supply, such as, a vehicle battery, for example. It is further understood that additional components such as regulators, resistors, and buffer circuits may be integrated between the power supply 16 and the components of the lighting system 10, as desired.

The color selection interface 12 is in electrical communication with the light source 14 and the power supply 16. The color selection interface 12 provides a user with a direct control of the light source 14 characteristics, such as, a color output 30, for example. As shown, the color selection interface 12 includes a user interface 18, a controller 20, and a background debugging mode interface 22.

The user interface 18 provides a means for the user to directly control and modify the functions of the controller 20. In certain embodiments, the user interface 18 includes a two-channel rotary encoder 24 and a push-button feature 26. The rotary encoder 24 provides an encoder output 28 to the controller 20 for modulating the color output 30 of the light source 14. The rotary encoder 24 may be any rotary encoder adapted to generate the encoder output 28 in response to a rotational position of the rotary encoder 24. For example, a clockwise rotation sends an increment indication to the controller 20 and a counterclockwise rotation sends a decrement indication to the controller 20. The controller 20 keeps track of the increment and decrement indications. Any number of encoder positions may be obtained by setting the limit in the configuration of the controller 20. The push-button feature 26 provides a control for initiating a color morphing mode, stopping the color morphing mode, and regulating the morphing speed of the color morphing mode. It is understood that other user engaged devices for initiating, stopping, and regulating the color morphing mode may be used, as desired. As a non-limiting example, the user may initiate the color morphing mode with a user-provided input 32 such as depressing and holding the push button feature 26 for a pre-determined time period. Other user-provided inputs 32 may be used to initiate, stop, and regulate the rotation functions of the color selection interface 12, as desired.

The controller 20 is in communication with the user interface 18 and the light source 14. As a non-limiting example, the controller 20 is a microcontroller. However, the controller 20 may be any device adapted to cooperate with the user interface 18 to provide the user with direct control of the light source 14 characteristics, such as, the color output 30, for example. As shown, the controller 20 is adapted to receive the encoder output 28. It is understood that additional components may be included for interfacing the rotary encoder 24 and the controller 20 such as a voltage divider and/or buffer circuits, for example. In certain embodiments, the controller 20 is adapted to modulate the electric current flowing to the light source 14 in response to the encoder output 28. As a non-limiting example, the controller 20 may be adapted to modulate the electric current flowing to each of the separate electrical lead for each color of the light source 14, thereby providing for an individualized control of each color's brightness. Other configurations may be used to control the color output 30 of the light source 14, as desired.

The background debugging mode interface 22 is in electrical communication with the controller 20. The background debugging mode interface 22 is an electronic interface that allows debugging of embedded systems. Specifically, the background debugging mode interface 22 provides in-circuit debugging functionality in the controller 20. The background debugging mode interface 22 may include any debugging hardware, such as, a debug module and a debug controller, as desired.

In use, the user-provided input 32 initiates the color morphing mode. In certain embodiments, the user depresses the push button feature 26 and holds the push button feature 26 in a depressed position for a set time period. It is understood that the time period may be pre-determined to be any period, as desired. After the set time period has been reached, the lighting system 10 enters the color morphing mode. In the color morphing mode, the three LED colors, namely red, green and blue, are each modulated by the controller 20 to present the full spectrum of available colors possible from the light source 14. Specifically, in the color morphing mode, the rotary encoder 24 may be rotated and thereby generate and transmit the encoder output 28 representing a direction of rotation to the controller 20. The controller 20 receives the encoder output 28, processes the encoder output 28, and adjusts the electric current flow to the light source 14 in response to the encoder output 28. The speed at which the visible colors morph or are presented to the user can be adjusted using the rotary encoder 24 functions. In one embodiment, a clockwise rotation is used to speed up the morphing, while a counter clockwise rotation is used to slow down the changing colors being presented. Once a desired color becomes visible, a short tap of the push button feature 26 can stop the color morphing mode and thereby freeze the visible color point for storage as a unique personal color. This storage can be confirmed by a short burst of flashes to inform the user that this color has been recognized and accepted into the lighting system 10. It is understood that other user-provided inputs 32 may be used to freeze the visible color, as desired.

The color selection interface 12 and the method for selectively modulating the color output 30 of the lighting system 10 provide control of the color output 30 of the lighting system 10 and a real-time color feedback to the user. By morphing the colors the user does not need to understand the process of mixing colors. The spectrum of colors is continuously modulated and presented to the user for direct viewing. The user need only stop the modulating process when the desired color of interested is displayed. This eliminates the need for three input control devices and any working knowledge of color mixing with light.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A color selection interface for controlling the output of a light source, the color selection interface comprising:
a user interface including a rotary encoder adapted to transmit an encoder output representing a direction of rotation, wherein the user interface provides a direct control of an initiation of a color morphing mode, a stopping of the color morphing mode, and a morphing speed of the color morphing mode; and
a controller in electrical communication with the light source and the user interface, wherein the controller is adapted to receive the encoder output and control the color output of the light source in response to the encoder output.

2. The color selection interface according to claim 1, wherein the controller includes a background debugging mode interface for in-circuit debugging functionality in the controller.

3. The color selection interface according to claim 1, wherein the user interface includes a user engaged device for controlling the initiation of the color morphing mode, the stopping of the color morphing mode, and the morphing speed of the color morphing mode, in response to a user-provided input.

4. The color selection interface according to claim 3, wherein the user engaged device is a push button.

5. The color selection interface according to claim 4, wherein the color morphing mode is initiated and stopped by a depression of the push button.

6. The color selection interface according to claim 4, wherein the direction of rotation of the rotary encoder determines the morphing speed of the color morphing.

7. A lighting system comprising:
a light source having at least one color light emitting device;
a user interface including a rotary encoder adapted to transmit an encoder output representing a direction of rotation, wherein the user interface provides a direct control of an initiation of the color morphing mode, a stopping of the color morphing mode, and a morphing speed of the color morphing mode; and
a controller in electrical communication with the light source and the user interface, wherein the controller is adapted to receive the encoder output and control the color output of the light source in response to the encoder output.

8. The lighting system according to claim 7, wherein the light source includes a separate electrical lead for each of at least two colors, thereby providing for an individualized control of each color's brightness.

9. The lighting system according to claim 7, wherein the user interface includes a user engaged device for controlling the initiation of the color morphing mode, the stopping of the color morphing mode, and the morphing speed of the color morphing mode, in response to a user-provided input.

10. The lighting system according to claim 9, wherein the user engaged device is a push button.

11. The lighting system according to claim 10, wherein the rotation of the rotary encoder is controlled by a rotation of the push button.

12. The lighting system according to claim 10, wherein the color morphing mode is initiated and stopped by a depression of the push button.

13. The lighting system according to claim 12, wherein the direction of rotation of the rotary encoder determines the morphing speed of the color morphing.

14. The lighting system according to claim 13, wherein a clockwise rotation increases the speed of color morphing and a counter-clockwise rotation decreases the speed of color morphing.

15. The lighting system according to claim 7, wherein the controller includes a background debugging mode interface for in-circuit debugging functionality in the controller.

16. A method for selectively modulating a color output of a lighting system, the method comprising the steps of:
providing a light source adapted to emit a color output;
providing a color selection interface in electrical communication with the light source, wherein the color selection interface is adapted to receive at least one user-provided input and modulate the color output of the light source in response to the at least one user-provided input; and
providing a user input for controlling at least one of an initiation of the modulation of the color output, a stopping of the modulation of the color output, and a speed of the modulation of the color output.

17. The method according to claim 16, wherein the light source includes at least one color light emitting device.

18. The method according to claim 17, wherein the light source includes a separate electrical lead for each of at least two colors, thereby providing for an individualized control of each color's brightness.

19. The method according to claim 16, wherein the color selection interface includes a user interface having a rotary encoder adapted to transmit an encoder output representing the direction of rotation of the rotary encoder, wherein the user interface provides a direct control of the initiation of the modulation of the color output, the stopping of the modulation of the color output, and the speed of the modulation of the color output, and a controller in electrical communication with the light source and the user interface, wherein the controller is adapted to receive the encoder output and control the color output of the light source in response to the encoder output.

20. The method according to claim 19, wherein the user interface includes a user engaged device for controlling the initiation of the modulation of the color output, the stopping of the modulation of the color output, and the speed of the modulation of the color output, in response to the user-provided input.
